(19) United States
(12) Patent Application Publication
(10) Pub. No.: US 2026/0330695 A1
(43) Pub. Date: Oct. 22, 2026

(54) LOOP FILTERING USING NEURAL NETWORKS

(71) Applicant: DOLBY LABORATORIES LICENSING CORPORATION

(72) Inventors: Jay Nitin Shingala, Bangalore (IN); Shireesh Vaman Kadaramandalgi, BANGALORE (IN); Ajay Shyam, Sullia (IN); Tong Shao, Sunnyvale, CA (US); Arjun Arora, Sunnyvale, CA (US); Peng Yin, Ithaca, NY (US); Siddarth Prakash Badya, BANGALORE (IN); Ajat Suneja, Bangalore (IN)

(73) Assignee: DOLBY LABORATORIES LICENSING CORPORATION, (US)

(21) Appl. No.: 18/876,552

(22) PCT Filed: Jun. 26, 2023
(86) PCT No.: PCT/US2023/026238

§ 371 Date: Dec. 18, 2024

Related U.S. Application Data
(60) Provisional application No. 63/432,613, filed on Dec. 14, 2022.

(30) Foreign Application Priority Data
Jul. 4, 2022 (IN) 202241038279
Dec. 22, 2022 (IN) 202241074543
Mar. 14, 2023 (IN) 202341017121

(51) Int. Cl. G06T 9/00; H04N 19/186; H04N 19/70; H04N 19/82

(52) U.S. Cl. CPC G06T 9/002; H04N 19/186; H04N 19/70; H04N 19/82

(57) ABSTRACT

Methods, systems, bitstream syntax, and fixed-point implementations are described for loop filtering using neural networks in image and video processing. Given an input image, a hybrid luma-chroma filter is proposed, wherein luma and chroma components are first processed by a first neural network and the output of the first network is subsequently processed by separate luma and chroma subnetworks. Finally, the outputs of the separate luma and chroma subnetworks are concatenated to generate the filtered output of the input image. Computational efficient methods using CP-decomposition are also described. Methods indicating the position of the neural-net loop filter relatively to other filters, such as the adaptive loop filter (ALF) are also discussed.

### CROSS-REFERENCE TO RELATED APPLICATIONS

This application claims priority to Indian Provisional Patent Application No. 202241038279, filed on Jul. 4, 2022; Indian Provisional Patent Application No. 202241074543, filed on Dec. 22, 2022; Indian Provisional Patent Application No. 202341017121, filed on Mar. 14, 2023; and U.S. Provisional Patent Application No. 63/432,613, filed on Dec. 14, 2022.

### TECHNOLOGY

The present document relates generally to images. More particularly, an embodiment of the present invention relates to filtering images using neural networks.

### BACKGROUND

In 2020, the MPEG group in the International Standardization Organization (ISO), jointly with the International Telecommunications Union (ITU), released the first version of the Versatile Video Coding standard (VVC), also known as H.266 (Ref. [8]). More recently, the same joint group (JVET) and experts in still-image compression (JPEG) have started working on the development of the next generation of coding standards that will provide improved coding performance over existing image and video coding technologies. As part of this investigation, coding techniques based on artificial intelligence and deep learning are also examined. As used herein the term “deep learning” refers to neural networks having at least three layers, and preferably more than three layers.

As appreciated by the inventors here, improved techniques for the coding of images and video based on neural networks are described herein.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Similarly, issues identified with respect to one or more approaches should not assume to have been recognized in any prior art on the basis of this section, unless otherwise indicated.

### BRIEF DESCRIPTION OF THE DRAWINGS

An embodiment of the present invention is illustrated by way of example, and not in way by limitation, in the figures of the accompanying drawings and in which like reference numerals refer to similar elements and in which:

FIG. 1 depicts an example architecture for joint luma-chroma loop filtering using a neural network (NN) according to prior art;

FIG. 2 depicts an example architecture for separate luma-chroma loop filtering using a NN according to prior art;

FIG. 3 depicts an example architecture for hybrid luma-chroma loop filtering using a NN according to an embodiment of this invention;

FIG. 4A depicts an example network architecture with CP-decomposition according to an embodiment of this invention;

FIG. 4B depicts an example network architecture network architecture which combines CP-decomposition and fusion of 1×1 convolutional layers according to an embodiment of this invention;

FIG. 4C depicts the network architecture of FIG. 4B with an additional CP-decomposition of the input and output 3×3 convolution layers of the neural network according to an embodiment of this invention;

FIG. 4D depicts the network architecture of FIG. 3 with CP-decomposition according to an embodiment of this invention;

FIG. 4E depicts the network architecture of FIG. 4D with an additional CP-decomposition of the input and output 3×3 convolution layers of the neural network according to an embodiment of this invention;

FIG. 4F depicts the network architecture of FIG. 4B with fusion of 3×1 and 1×3 separable convolution layers into a single 3×3 separable convolution layer according to an embodiment of this invention;

FIG. 5A depicts a network architecture for VVC loop filtering using a joint luma/chroma NNLF model according to an embodiment of this invention;

FIG. 5B depicts a network architecture for VVC loop filtering using a separate luma/chroma NNLF model according to an embodiment of this invention;

FIG. 6 depicts an example of a fixed-point representation of number;

FIG. 7A depicts an example of localized hidden-layer normalization according to an embodiment of this invention;

FIG. 7B depicts an example process for global normalization based on a largest weight with forward propagation of normalization; and

FIG. 7C depicts an example process for global normalization based on geometric mean and bidirectional propagation of normalization.

### DESCRIPTION OF EXAMPLE EMBODIMENTS

Example embodiments for loop filtering using neural networks in image and video coding are described herein. In the following description, for the purposes of explanation, numerous specific details are set forth in order to provide a thorough understanding of the various embodiments of present invention. It will be apparent, however, that the various embodiments of the present invention may be practiced without these specific details. In other instances, well-known structures and devices are not described in exhaustive detail, in order to avoid unnecessarily occluding, obscuring, or obfuscating embodiments of the present invention.

### SUMMARY

Example embodiments described herein relate to image and video coding using neural networks. In an embodiment, a processor receives an input image with luma and chroma color components, and:
applies a first neural network (NN) to both the luma and the chroma color components of the input image to generate a first luma output and a first chroma output;
applies a second neural network to the first luma output to generate a second luma output;
applies a third neural network to the first chroma output to generate a second chroma output; and
concatenates the second luma output and the second chroma output to generate a colored filtered output.

In a second embodiment, a processor receives high-level syntax indicating that loop filtering using neural networks (NNLF) is enabled for decoding a current picture. Then, the processor:
parses the high-level syntax for extracting parameters indicating a recommended position of an adaptive loop filter (ALF); and
decodes the current picture based on the ALF position parameters to generate an output picture, wherein the ALF position parameters specify one of:
performing ALF filtering after the NNLF;
performing ALF filtering before the NNLF;
replacing the ALF filtering by a convolutional neural network (CNN) positioned after the NNLF; and
performing ALF filtering before an enhanced NNLF using as NNLF input ALF classification data.

### Example Coding Model Using Deep Learning

Deep learning-based image and video compression approaches are increasingly popular, and it is an area of active research. Current research in neural-networks (NN) based coding can be divided in two general frameworks: a “hybrid” neural network based framework (e.g., Ref. [1]), which simply replaces one or more existing coding or decoding modules with their corresponding neural-network-based implementation, where each NN module is trained and optimized on its own, and an “end-to-end” neural network, where training and optimizing is done on the whole network (Ref. [9]). The proposed neural net filters are applicable to either architecture. The term YUV420 denotes a luma-chroma color space, where chroma is sub-sampled by two in both the horizontal and vertical dimensions, such as YCbCr 4:2:0, and the like. While examples refer to a neural network loop filter (NNLF), the techniques are applicable to a variety of other NN-based filters which remove noise artifacts or improve image quality, such as NN post filtering, super-resolution filtering, and the like.

Existing NNLF designs (Refs. [2-4]) yield close to 5% to 10% improvement in coding efficiency (BDrate), but at a very high computational cost, ranging from 33 to 625 kMAC (thousands of multiply-accumulations) operations per pixel. Embodiments presented herein offer improved coding efficiency at a reduced computational cost.

### Hybrid Luma-Chroma NN Model

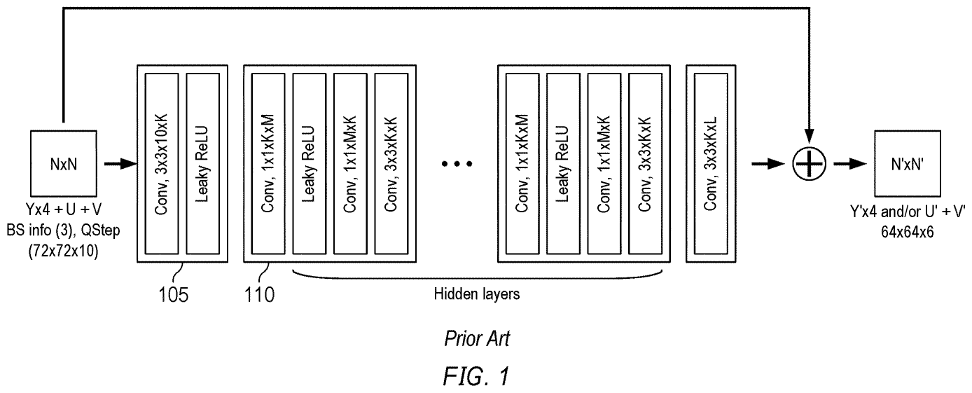

In the current literature, NNLF models can be divided into two main categories: joint luma/chroma models and separate luma/chroma models. These categories are based on whether the luminance (Y) signal and the chroma (UV) signal share the same NN. For joint models two typical approaches are used to feed a YUV420 signal into the NN. In Ref. [3], as depicted in FIG. 1, the Y signal is interleaved with the UV signal, and a total of six planes are used. In addition to these six planes, four additional planes of Y, U, V boundary strength maps (BS_{Y}, BS_{U}, BS_{V}) and a slice quantization parameter (QStep) are used to form 10 input channels as shown in FIG. 1. As depicted in FIG. 1, the architecture contains n filter blocks, including n−2 filter blocks used as hidden layers. The first layer (105) uses a 3×3 convolution layer with an activation layer (e.g., leaky ReLU) and outputs K channels (feature maps). Each hidden filter block (110) consists of two 1×1 convolution layers with an activation layer) (e.g., a leaky ReLU) between them, and followed by a 3×3×M×K convolution layer, where the value of M is set to be larger than the value of K, and the notation C×C×M×K denotes a C×C convolution layer with M inputs and K outputs. By setting different values to n, M, and K, models with different complexity can be created, e.g., n=13, M=72, K=24, or, n=14, M=216, K=72. The final layer outputs filtered luma-chroma residual channels (L=6) which consists of the 4 luma planes (Y signal) and two chroma planes (UV signal). These are added back to the NNLF input samples to get the final filtered output which is used as input to the adaptive loop filter (ALF) in Ref. [3].

The input size of the NN filtering process is 144×144, including the current coding tree unit (CTU) and 8 neighboring samples to each side of the current CTU. The luma samples are interleaved into four 72×72 sized blocks before being used as inputs to the filtering process. The output tensor corresponds to the filtered CTU samples organized as 64×64 blocks by cropping the center region of the 72×72 filtered output, including 4 luma blocks and/or 2 chroma blocks. The output tensor of NNLF correspond to filtered luma-chroma residual channels which are scaled and added back to the NNLF input samples to get final filtered output in Ref. [3]. During training stage, no scaling is applied, and the mean square error (MSE) of the filtered output and original samples are minimized using a weighted L2 loss function. During the inference stage, the scaling parameters for luma and chroma arc signaled in the slice header by the encoder to minimize the mean square error (MSE) of filtered samples and original samples of the current frame or image.

Alternatively, as described in Ref. [4], the chroma (UV) samples are first up-sampled to match the resolution of the Y component, and all three components are fed to a single NN filter. At the output of the NN filter, the chroma components are down-sampled back to their original (input) resolution (e.g., in 4:2:0 format).

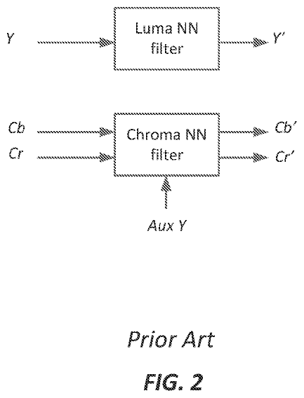

In a separate luma/chroma NN filter, as depicted in FIG. 2 (Ref. [2]), the Y signal and the UV (CbCr) signals use two distinct and separate NNs to generate filtered outputs (Y′Cb′Cr′). In some embodiments, the Chroma NN may also use an auxiliary luma input (Aux Y).

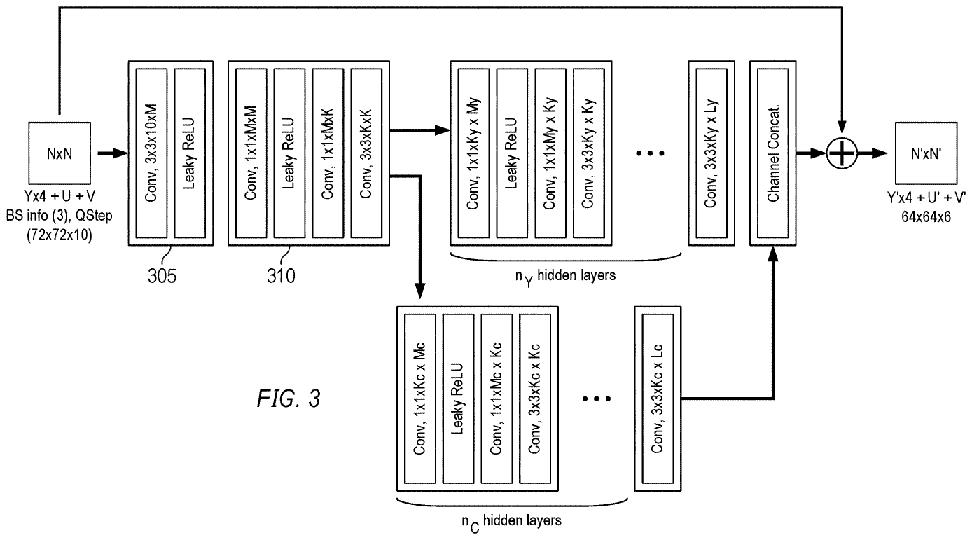

FIG. 3 depicts an example split architecture for luma/chroma filtering according to an embodiment. The input to the network are a joint Y and UV signal. For the NN, part of the network is shared by both luma and chroma and part of the network is split into two separate paths for the luma and chroma components. The corresponding luma/chroma channels can also be different. The motivation behind it is that the characteristics of luma and chroma signals are different. Therefore, chroma components might require less channels and/or less layers than luma component without losing performance. That is why separate paths might be able to achieve a similar performance while reducing complexity. In addition, because luma/chroma signals still have some cross-component correlation, a joint path at the beginning or the end of the network can help exploit the correlation.

As an example, in FIG. 3, the architecture combines the following NN components:

Input N×N, Y×4+U+V, BS Info (×3), QStep; (e.g., 72×72×10)

Joint input path:
(3×3) convolution, 3×3×10×M (10 inputs, M outputs)·
Lcaky RcLU
(Common hidden layer)
Conv, 1×1×M×M
Leaky ReLU
Conv 1×1×M×K
Conv 3×3×K×K

Luma path, n_{y} hidden layers of:
Conv, 1×1×Ky×My
Leaky ReLU
Conv 1×1×My×Ky
Conv 3×3×Ky×Ky

### Followed by Conv, 3×3×Ky×Ly

Chroma path, n_{c} hidden layers of:
Conv, 1×1×Kc×Mc
Leaky ReLU
Conv 1×1×Mc×Kc
Conv 3×3×Kc×Kc

### Followed by Conv, 3×3×Kc×Lc

Joint output path
Channel Concat

### Output: N′×N′, Y′×4+U′+V′ (e.g., 64×64×6)

Compared to FIG. 1, it is also worth noting the following differences: In the first layer (305), instead of using a 3×3×10×K convolution layer (see 105), a 3×3×10×M convolution layer is used instead, and in the common hidden layer (310), instead of using a 1×1×K×M convolution layer (see 110), a 1×1×M×M convolution layer is used instead.

In an embodiment, using n_{y} hidden layers in the luma path and n_{c} hidden layers in the chroma path, the complexity in kMAC/pixel of the proposed architecture can be computed as follows:
Total MACs in Luma path=n_{y}*(2*K_{y}*M_{y}+9*K_{y}*K_{y})+9*K_{y}*L_{y}
Total MACs in Chroma path=n_{c}*(2*K_{c}*M_{c}+9*K_{c}*K_{c})+9*K_{c}*L_{c}
Total MACs in common path=9*10*M+M*M+K*M+9*K*K
   For example:
If in common path: N=72, K=24, M=72, then MACs=18,576
If in Luma path: n_{y}=10, K_{y}=16, M_{y}=48, L_{y}=4, then MACs=38,976
If in Chroma path: n_{c}=10, K_{c}=8, M_{c}=24, L_{c}=2, then MACs=9,744
   Total MACs=67,296 to process 4 luma (and 2 chroma) samples and boundary pixels from 72×72 are ignored in output to get 64×64.
   Hence, MACs/pixel=(67,296*72*72)/(64*64*4)=21.292 kMAC/pixel. Compared to Ref. [3], which reports a complexity of about 33.6 kMAC/pixel, the proposed architecture requires approximately 0.633 of the computations.

### Tensor Decomposition Approaches

Applying tensor decomposition is one of many approaches to reduce NN computational complexity. There are several tensor decomposition approaches. For example, the depth-wise separable convolution (DSC) approach has been tried in several JVET contributions, such as Ref. [5]. In an embodiment, NN complexity is reduced using CP-decomposition (Ref. [6]). In CP-decomposition (CP comes from CANDECOMP/PARAFAC model), a 4D convolution kernel tensor is decomposed into a sequence of four convolutional layers with small kernels. The first convolution layer is a pointwise convolution, the second and third layers are spatial convolutions in X and Y directions, and the fourth convolution is again a pointwise convolution in the channel dimension.

Regular convolution for output channel t can be written as

$$V ( x , y , t ) = {\sum }_{i = x - δ}^{x + δ} {\sum }_{j = y - δ}^{y + δ} {\sum }_{s = 1}^{S} K ( i - x + δ , j - y + δ , s , t ) U ( i , j , s ) , \qquad ( 1 )$$

where U is an input tensor with S channels, K is kernel of size d×d×S per output channel, and
V is the output tensor.
CP rank R approximation to the above convolution, for channel t, is given by:

$$V ( x , y , t ) = {\sum }_{r = 1}^{R} {K}^{t} ( t , r ) ( {\sum }_{i = x - 5}^{x + 6} {K}^{x} ( i - x + δ , r ) ( {\sum }_{j = y - δ}^{y + δ} {K}^{y} ( j - y + δ , r ) ( {\sum }_{s = 1}^{S} {K}^{s} ( s , r ) U ( i , j , s ) ) ) ) , \qquad ( 2 )$$

where kernel K is approximated as

$$K ( i , j , s , t ) = {\sum }_{r = 1}^{R} {K}^{x} ( i - x + δ , r ) {K}^{y} ( j - y + δ , , r ) {K}^{s} ( s , r ) {K}^{t} ( t , r ) , \qquad ( 3 )$$

where K^{x}, K^{y}, K^{s}, K^{t} are d×R, d×R, S×R, and T×R tensors along different dimensions. The complexity of CP decomposition in terms of MAC/pixel, compared to compared to STd², is given as R(S+2d+T). If the recommended rank

$$R ≅ \frac{S T}{S + T}$$

is chosen tor decomposition, then the improvement factor will be d². For the training, CP-decomposition can reuse the trained model using regular convolution and fine-tune it.

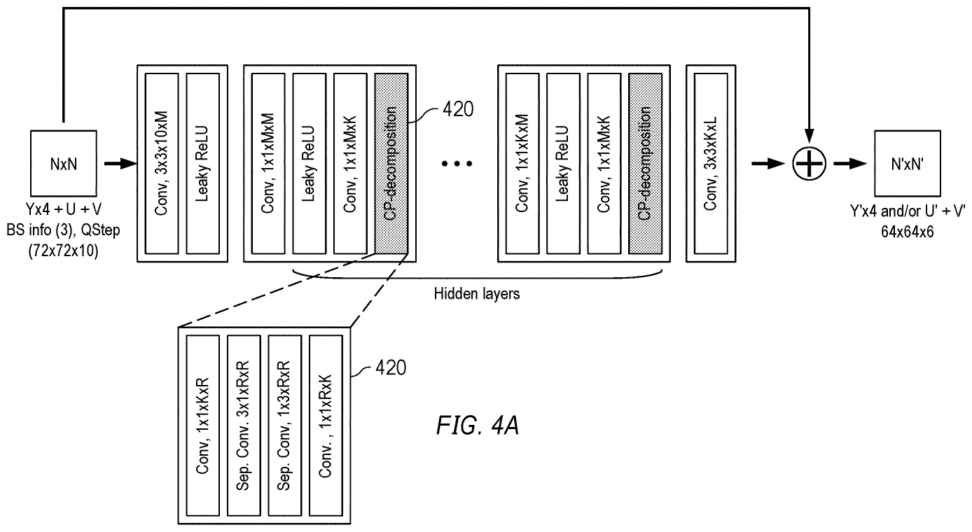

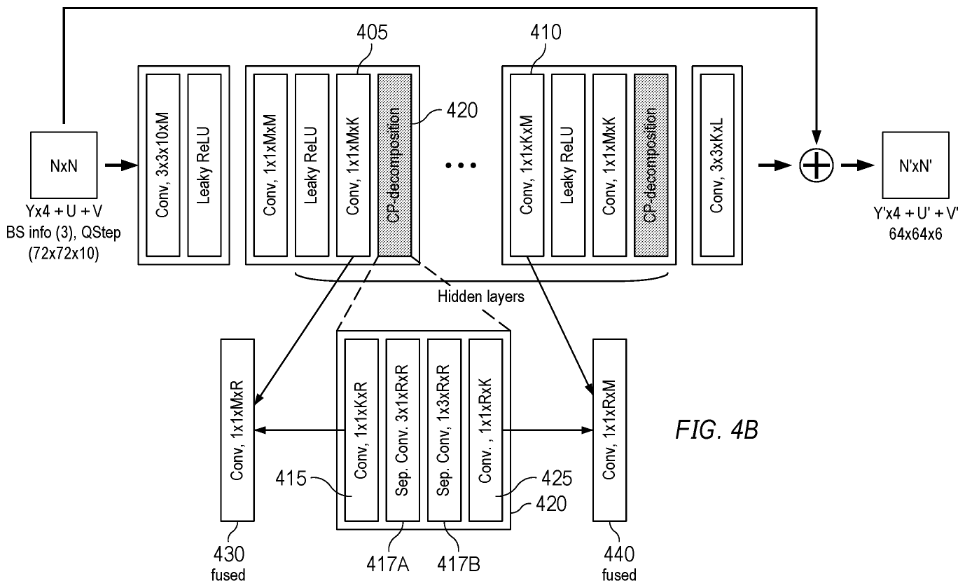

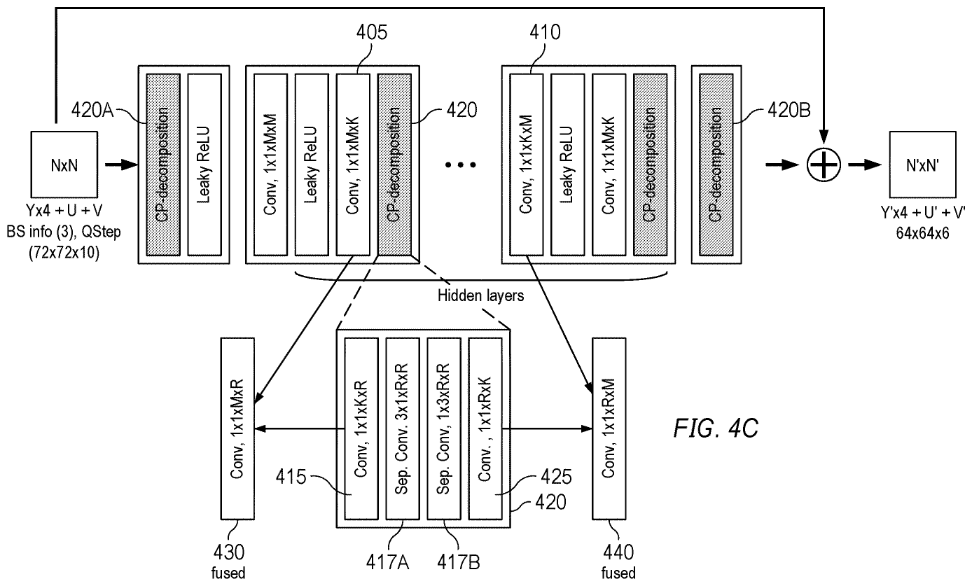

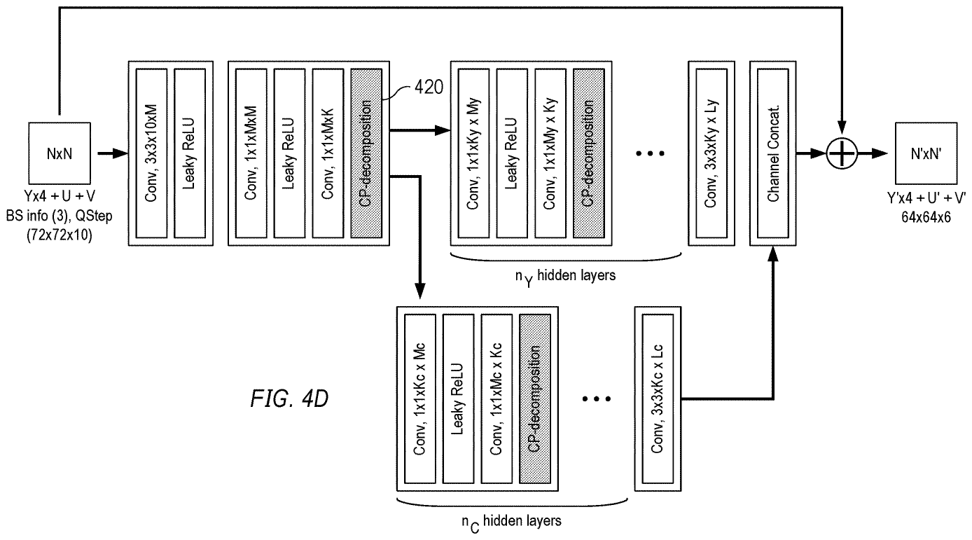

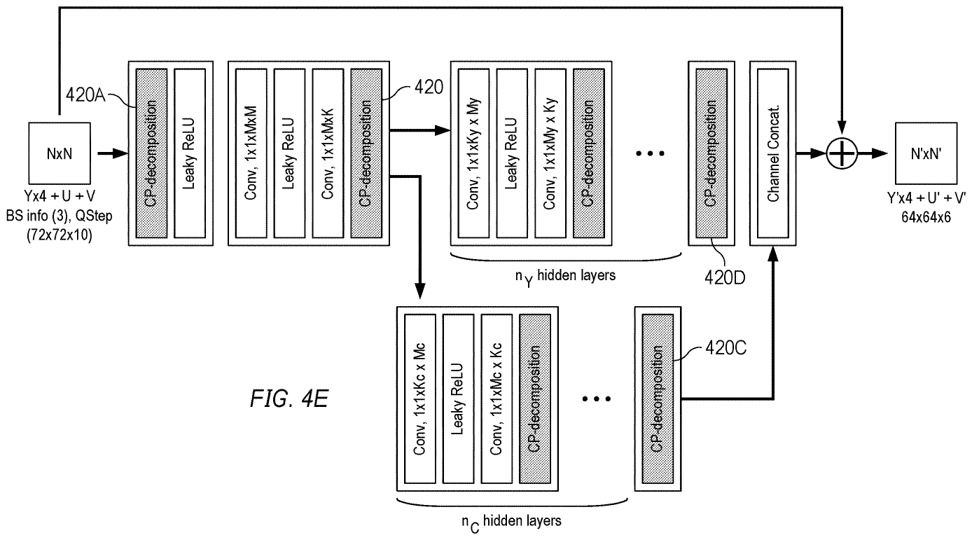

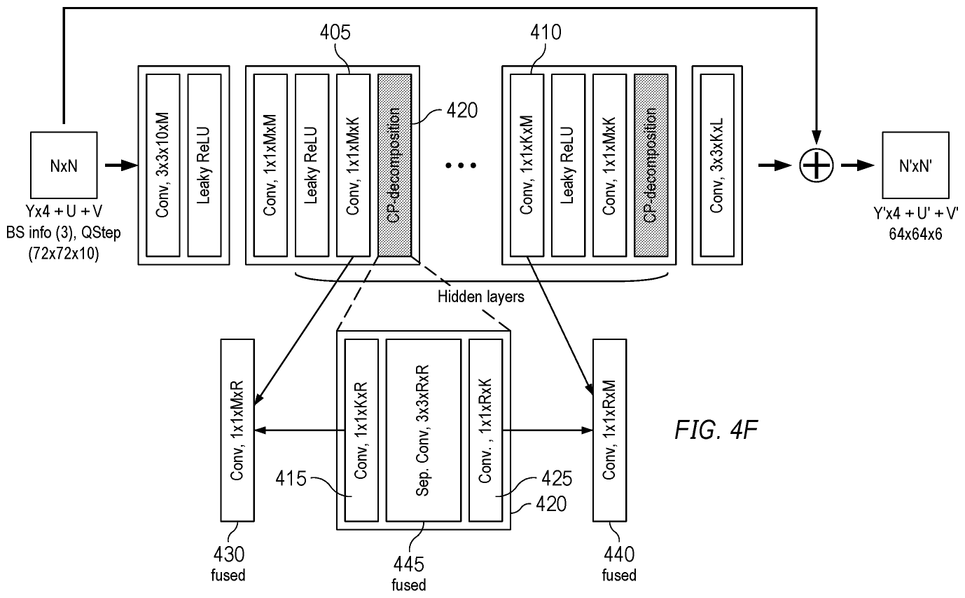

As an example, FIG. 4A depicts an example of applying CP-decomposition (420) on the architecture depicted in FIG. 1, as modified in the common layer of FIG. 3, that is: in the first layer, instead of using a 3×3×10×K convolution layer (see 105), a 3×3×10×M convolution layer is used instead, and in the first hidden layer, instead of using a 1×1×K×M convolution layer (see 110), a 1×1×M×M convolution layer is used instead.

As depicted in FIG. 4A (detail of 420), the 3×3 convolutions of each hidden layer are decomposed into four layers with rank R (see 420):
1^{st} layer: 1×1×K×R pointwise convolution
2^{nd} layer: 3×1×R×R separable convolution
3^{rd} layer: 1×3×R×R separable convolution
4^{th} layer: 1×1×R×K pointwise convolution

Applying CP-decomposition, compared to Ref. [3], for R=24, applied to all the hidden layers, the complexity reduction factor is about 1.6×. When using R=12, the complexity reduction factor is about 1.8×.

As depicted in FIG. 4A and FIG. 4B, in CP-decomposition (420), the first decomposed layer (415) (1×1×K×R) can be fused with the 1×1×M×K preceding 4 layer (405) of the hidden unit resulting in an effective fused single layer (430) (1×1×M×R). Similarly, the last CP-decomposed layer (425) (1×1×R×K) can be fused with the next hidden unit's first layer (410) (1×1×K×M) to realize the same functionality by a single fused (1×1×R×M) layer (440). This fusion of adjacent 1×1 pointwise convolution is illustrated in FIG. 4B. This fusion is possible because there are no nonlinear activations present between the layers that are going to be fused, resulting in further complexity reduction. The fusion network in FIG. 4B can result in minor differences in inference output because of the differences in order of floating-point operations, but it has negligible difference in coding performance compared to CP-decomposed NNLF filter without fusion in FIG. 4A.

Applying CP-decomposition with fusion, compared to Ref. [3], for R=24, applied to all the hidden layers, the complexity reduction factor is about 2.1×. When using R=12, the complexity reduction factor is about 3.3×.

FIG. 4C depicts the network architecture of FIG. 4B with additional CP-decomposition of the input 3×3 convolution layer (420A) and the output 3×3 convolution layer (420B). The input 3×3×10×M convolution layer (420A) is decomposed into 4 layers of 1×1×10×R pointwise convolution, 3×1×R×R separable convolution, 1×3×R×R separable convolution, and 1×1×R×M pointwise convolution. Similarly, the output 3×3×K×L convolution (420B) is decomposed into 4 layers of 1×1×K×R pointwise convolution, 3×1×R×R separable convolution, 1×3×R×R separable convolution, and 1×1×K×L pointwise convolution. For R=24, with the additional decomposition of the input and output layers, the overall complexity reduction factor is now about 2.3×.

FIG. 4D depicts an example embodiment for applying CP-decomposition to the split architecture of FIG. 3. As discussed earlier, layers of CP-decomposition (420) can also be fused with prior or subsequent 1×1 convolutional layers as applicable. The CP-decomposition with rank R=24 applied to all hidden layers achieves complexity reduction factor of 2.5×. The CP-decomposition with rank 24 applied to all hidden layers and the fusion of adjacent 1×1 pointwise convolution achieves complexity reduction factor of 3×.

FIG. 4E depicts the network architecture of FIG. 4D with additional CP-decomposition of the input 3×3 convolution layer (420A) and the luma, chroma output 3×3 convolution layers (420D, 420C). The input 3×3×10×M convolution layer (420A) is decomposed into 4 layers of 1×1×10×R pointwise convolution, 3×1×R×R separable convolution, 1×3×R×R separable convolution, and 1×1×R×M pointwise convolution. The output luma 3×3×Ky×Ly convolution (420D) is decomposed into 4 layers of 1×1×Ky×Ry pointwise convolution, 3×1×Ry×Ry separable convolution, 1×3×Ry×Ry separable convolution, and 1×1×Ky×Ly pointwise convolution. Similarly, the output chroma 3×3×Kc×Lc convolution (420C) is decomposed into 4 layers of 1×1×Kc×Rc pointwise convolution, 3×1×Rc×Rc separable convolution, 1×3×Rc×Rc separable convolution, and 1×1×Kc×Lc pointwise convolution. For R=24, Ry=16, and Rc=8, with the additional decomposition of input and output layers, the overall complexity reduction factor is about 3.4×.

As depicted in FIG. 4F, the decomposed separable convolution layers of 3×1 (417A) and 1×3 (417B) depicted in FIG. 4B can be fused into a single 3×3 separable convolution (445). This fusion helps in reducing the number of layers in the network, which can help in lowering latency of the network and memory access overhead, and can take advantage of hardware/software implementations optimized for a 3×3 convolution kernel size but not optimized for 3×1 or 1×3 row-wise or column-wise convolution operations. This fusion is possible because there are no nonlinear activations present between the layers being fused and the fused block is mathematically equivalent to the layers being fused. The additional ‘mac’ (multiply-accumulate) operations due to fusion (9×R×R in the fused layer vs 6×R×R before fusion) have negligible impact on the overall complexity of filtering. The resulting ‘mac-complexity’ increase of FIG. 4F is less than 2% of that in FIG. 4B, while an implementation specific speed up of up to 30% was observed.

### NNLF and ALF Pipeline Issue

When NNLF is used in the VVC framework (Ref. [8]), the position of NNLF is very important. VVC contains several in-loop filters, such as after inverse luma mapping-chroma scaling (LMCS), the deblocking filter (DF), sample adaptive offset (SAO), adaptive loop filter (ALF) and cross-component ALF (CCALF), which are applied in order to improve the quality of the decoded signal. When NNLF is proposed, DF/SAO can be incorporated into the NNLF. So far, all JVET contributions could not eliminate ALF and CCALF because of the additional gain brought by them. In addition, because ALF and CCALF need to compute coefficients based on the distortion between decoded/filtered signal and the original signal, it is found that highest gain can be achieved by placing ALF and CCALF after NNLF; however, the placement of the ALF and CCALF filters may cause pipeline issues because in real applications NNLF is most likely implemented by a graphics processing unit (GPU), while ALF, CCALF, and other decoding modules are implemented by the CPU. To resolve such pipeline issues, the following embodiments are described.

First Embodiment: Replace ALF and CCALF with a Convolutional NN (CNN)

Tests show that the main gain coming from ALF and CCALF is for the chroma component. A CNN, conceptually wise, is essentially ALF and CCALF. In an embodiment, one can add a separate CNN after NNLF. To be more specific, the separate CNN can only include a layer that performs convolution or a dot product of the convolution kernel with the layer's input matrix. This CNN can be pretrained or can be trained online (so-called CNN model update). For the latter method, one needs to send the coefficients with the bitstreams. The updated coefficients can be signalled for intra pictures or inter pictures which are referenced by other pictures.

### Second Embodiment: Enhanced NNLF

An alternate method is to use the NNLF filter as the last stage of all the loop filters but with added input ALF classification data. This architecture will be denoted as ‘enhanced NNLF.” The advantage of this approach is that it does not impact the hardware pipeline of conventional loop filters (e.g., Deblock, SAO, and ALF) in VVC. This method uses 4×4 block classification metrics based on horizontal, vertical, diagonal gradients, and local activity, which are used in the current VVC ALF filter, as additional feature inputs to the NNLF filter. In addition to this, separate NNLF models for luma and chroma can be used.

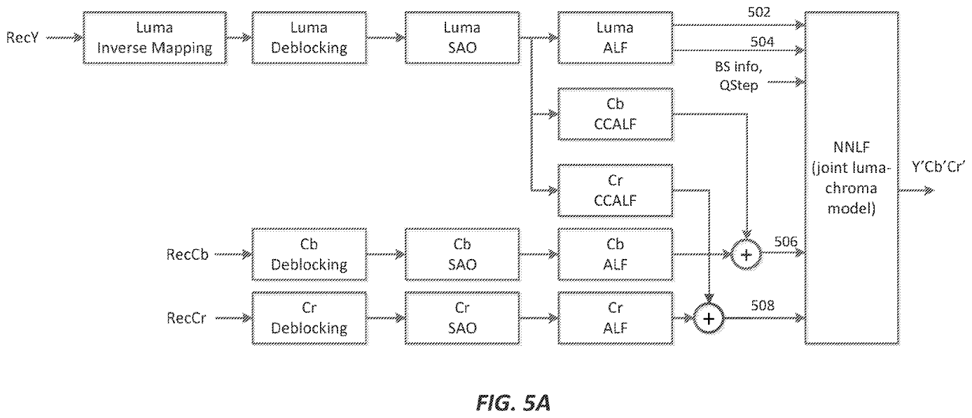

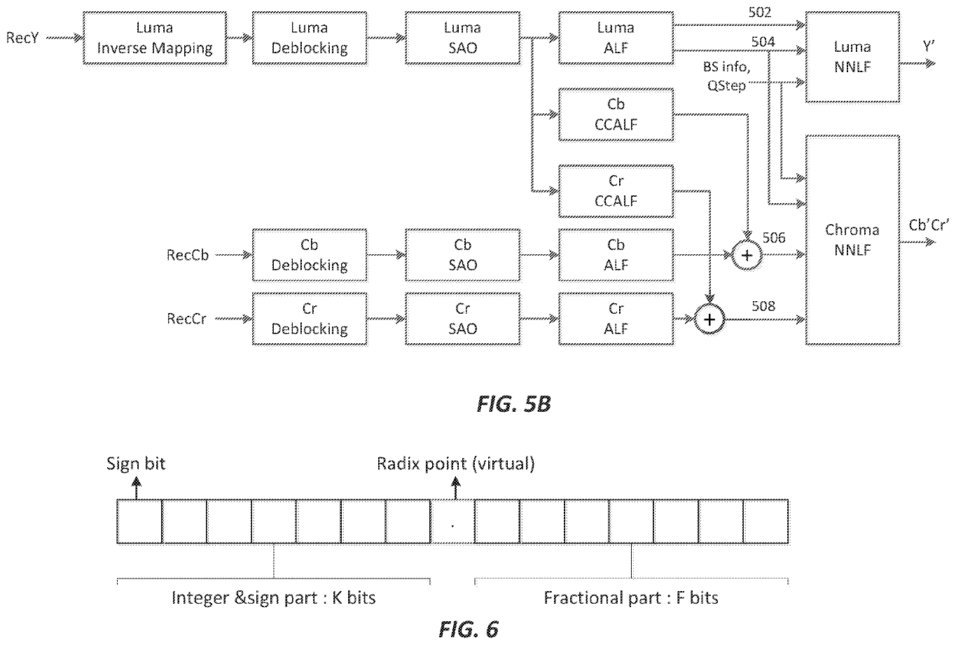

FIG. 5A depicts an embodiment for VVC loop filtering using a joint (or hybrid) NNLF network. As depicted in FIG. 5A, reconstructed luma samples (RecY) are processed sequentially by inverse luma mapping (inverse LMCS), deblocking, SAO, and ALF filtering to generate luma ALF classification data (502) and luma ALF samples (504). The output of Luma SAO is also processed by a Cb CCALF filter and a Cr CCALF filter.

Reconstructed chroma samples (RecCb, RecCr) are processed sequentially by deblocking, SAO, and ALF, and their output is added to the corresponding outputs of the Cb/Cr CCALF filters to generate Cb ALF samples (506) and Cr ALF samples (508). Finally, ALF classification data (502), luma ALF samples (504), chroma AL samples (506, 508), together with BS info and QStep data, are merged together as input to the NNLF to generate the filtered output Y′Cb′Cr′.

FIG. 5B depicts an alternative embodiment for VVC loop filtering using separate luma and chroma NNLF networks. The front-part of the design is the same as in FIG. 5A; however, the generated data (e.g., 502, 504, 506, and 508) feed two separate networks. As depicted in FIG. 5B, the luma NNLF filter does not use any chroma samples; however, the chroma NNLF filter can use the filtered luma ALF samples (504) as part of its input.

### Syntax Examples

The proposed tools may be communicated from an encoder to a decoder using high-level syntax (HLS) which can be part of the video parameter set (VPS), the sequence parameter set (SPS), the picture parameter set (PPS), the picture header (PH), the slice header (SH), or as part of supplemental metadata, like supplemental enhancement information (SEI) data. An example syntax is depicted in Table 1. Alternatively, if the specific architectures are predetermined and known by both the encoder and the decoder, no such signaling may be required.

TABLE 1
An example of high-level syntax for NNLF adaptation

| | Descriptor |
|---|---|
| NNLF_adaptation_syntax( payloadSize ) { | |
| nnlf_adaptation_enabled_flag | u(1) |
| if( nnlf_adaptation_enabled_flag ) { | |
| hybrid_luma_chroma_model_idc | ue(v) |
| tenor_decompostion_enabled_flag | u(1) |
| if( tensor_decomposition_enabled_flag ) { | |
| tensor_decomposition_idc | ue(v) |
| if (tensor_decomposition_method == 1) | |
| cp_decomp_rank_minus1 | ue(v) |
| } | |
| ALF_placement_idc | ue(v) |
| } | |
| } | |

nnlf_adaptation_enabled_flag equal to 1 specifies NNLF adaptation is enabled for the decoded picture. nnlf_adaptation_enabled_flag equal to 0 specifies NNLF adaptation is not enabled for the decoded picture.
hybrid_luma_chroma_model_idc identifies the NNLF model.

hybrid_luma_chroma_model_idc equal to 0 specifies hybrid luma chroma model is not applied for NNLF. hybrid_luma_chroma_model_idc equal to 1 specifies hybrid luma chroma model as shown in FIG. 3 might be applied for NNLF. The other values of hybrid_luma_chroma_model_idc are reserved for future use.

tensor_decomposition_enabled_flag equal to 1 specifies tensor decomposition is used to reduce NNLF complexity. tensor_decomposition_enabled_flag equal to 0 specifies tensor decomposition is not used to reduce NNLF complexity.

tensor_decomposition_idc identifies tensor decomposition methods as specified in Table 2. The other values of tensor_decomposition_idc are reserved for future use.

TABLE 2
tensor_decomposition_idc values

| Value | Description |
|---|---|
| 0 | CP-decomposition |
| 1 | Depthwise separable |
| | convolution |
| 2 | Optimal separable |
| | convolution |
| 3 | Low rank decomposition |

cp_decomp_rank_minus1 plus 1 specifics the rank of CP decomposition.

ALF_placement_idc identifies ALF placements as specified in Table 3.

TABLE 3
ALF_placement_idc values

| Value | Description |
|---|---|
| 0 | ALF is placed after NNLF |
| 1 | ALF is placed before NNLF |
| 2 | ALF is replaced by a CNN |
| | and added after NNLF |
| 3 | Use enhanced NNLF with |
| | joint luma/chroma |
| 4 | Use enhanced NNLF with |
| | separate luma/chroma |

### Fixed-Point Implementation

Embodiments of this disclosure present different methods to quantize the floating-point convolution weights and bias layers of a neural network to realize an efficient fixed-point neural network without affecting its performance in terms of accuracy of the output. The main goals of fixed-point integer realization of any neural network are:
1. Bit exact inference: achieve identical output for a given input on any hardware or software platform.
2. Low complexity: software and hardware friendly implementation using integer arithmetic operations aimed at complexity reduction, higher throughput, and power efficiency.
3. Accuracy: maintain highest possible accuracy that achieves least possible deviations compared to floating point inference.

Although all the methods in this disclosure are applicable for any convolutional feed forward neural network, the illustration and implementation are realized using the low complexity neural network-based loop filter (NNLF) described earlier.

As loop filtering is typically a normative process in any video decoder, it is highly desirable for a decoder to have bit exact output on any hardware/software platform. As bit exact output is not feasible in floating point inference, fixed-point implementation is required. For example, the NNLF floating point models are initially trained either in PyTorch or TensorFlow and later converted to fixed-point for this process.

All the methods proposed in this invention are aimed at realizing the integer implementation of NNLF. Without limitation, and as an example, the integer implementation and verification is done using SADL (Small Ad hoc Deep-Learning Library) which is a light-weight library to perform neural-network inference in pure C++. In addition, typically, a 16-bit fixed point integer implementation (int16) is more desirable than a 32-bit integer implementation (int32) for faster implementation and lower storage costs. Without limitation, and as an example, the performance of fixed-point implementations will be measured based on how it performs compared to its floating-point implementation, shown in Table 4, for All Intra, Main 10, for the JVET “Class D” set of test images. For example, compared to a VVC encoder without an NNLF filter, a trained NNLF filter, in floating-point implementation, improves Y-PSNR by 5.04%.

TABLE 4
Example NNLF floating-point performance
All Intra Main10

| | Y- | U- | V- |
|---|---|---|---|
| | PSNR | PSNR | PSNR |
| Class D | −5.04% | −5.84% | −6.94% |

FIG. 6. depicts an example of fixed-point representation of number. The K bits before a virtual radix point represent the integer part, including the sign bit, and the F bits after the radical point represent the fractional part. The Q format or Q factor of fixed-point representation is determined by the number of F bits which represent the fractional part, thus, for example, the term Q14 denotes a fixed-point implementation with F=14 bits. Thus, for Int16, Q11 indicates that 5 bits are used for sign and the integer part, and 11 bits are used for the fractional part, for a total of 16 bits.

A high accuracy efficient fixed-point realization of NNLF involves determining optimal Q formats for the weights and biases of all the convolution layers as well as the optimal Q format for the input and intermediate outputs of each layer and the final output of the NNLF filter.

All the Q-format related operations in fixed-point convolutions are explained below:
1. The normalized input x (0,1) is multiplied by an optimal Q factor (say Qin) based on the required precision.
2. The weights (A) and bias (B) of each convolution are also represented by their own Q factors Q_{A} and Q_{B} respectively.
3. It is desirable that resulting convolution output y=Ax+B is also in Qᵢₙ format. Hence the multiply and accumulated result of y′=Ax is right shifted by the Q factor of the conv layer Q_{A} to bring the output y′ back to the input Q format Qᵢₙ.
4. In the bias addition layer y=y′+B, the input y′ is scaled up or down before addition to match the bias Q format Q_{B} based on the difference of the input and bias q formats (Qᵢₙ−Q_{B}). It is desirable that Q format of the bias layer Q_{B} and the input Qᵢₙ is identical so that there is not loss of precision or overflow of data due to shifts introduced in addition.
   All the remaining sections show the implementation approaches for int32 and int16 fixed point implementation and corresponding PSNR results.

Table 5 depicts some experimental results using various fixed-point implementations and how they compare with the floating-point results of Table 4. The term (w) refers to weights and the term (b) refers to biases.

With Int32, Q14, the results with this configuration closely match the reference floating point results. When Q11 is used, as expected, a loss in performance is detected. If one applies dynamic Q for the weights, but with a fixed Q11 for the bias, performance improves; however, if one applies the more desirable 16-point implementation, one observes significance loss in performance, due to the overflow of the variables during the convolution operations.

The convolution weights and bias of some layers have very high magnitude. These

values are mainly seen in the 1×1 convolution layers. These values are very high in the floating-point domain. Hence even after right-shifting by the Q factor of that layer, the outputs of the layers' magnitude tend to increase. This means the output energy of few of the convolution layers is higher than that of the input. This increase in magnitude will cause the overflow in subsequent convolution layers.

TABLE 5
Example NNLF fixed-point performance
All Intra Main10

| | Y- | U- | V- |
|---|---|---|---|
| | PSNR | PSNR | PSNR |
| Floating point | −5.04% | −5.84% | −6.94% |
| Int32, Q14 (w) and (b) | −5.03% | −5.88% | −6.93% |
| Int32, Q11 (w) and (b) | −4.88% | −5.51% | −6.67% |
| Int32, dynamic Q (w), | −4.91% | −5.58% | −6.72% |
| Q11 (b) | | | |
| Int16, dynamic Q (w), | −1.47% | −1.28% | −1.26% |
| Q11 (b) | | | |

### Int16 Implementation Based on Dynamic Weight Renormalization

In principle, the output of the NNLF filter after all convolution layers will have similar (or lower) energy than the input. If few layers of the model with large magnitude convolution weights result in amplification, few other layers in the subsequent pipeline would have much smaller weights that would bring down the dynamic range to that of the input. As high magnitude convolutional layers result in overflow, it is desirable to normalize the convolutional weights of such a layer (e.g., i) by a scaling factor W (where, W>1) to prevent overflow as show in the equation below:

yⁱ==Aⁱxⁱ+Bⁱ⇒y^{i′}=yⁱ/W=(Aⁱ/W)xⁱ+Bⁱ/W (4)

As the output y^{i′} is now normalized by W, this factor needs to be rescaled in a subsequent (or previous) layer (e.g., j) whose convolution weights are sufficiently smaller in magnitude, as shown in the equation below to ensure y^{j}=y^{j′}:

y^{j}=A^{j}x^{j}+B^{j}⇒y^{j′}=(A^{j}*W)x^{j′}+B^{j} (5)

Note that the bias term is not rescaled above as per the derivation shown below for j=i+1:

y^{j}=A^{j}x^{j}+B^{j}=A^{j}yⁱ+B^{j}=(A^{j}*W)*y^{i′}+B^{j}=(A^{j}*W)x^{j′}+B^{j} (6)

In a nutshell, the layers with larger magnitude are divided by a scaling factor and the layers with smaller magnitudes are multiplied back with these scaling factors. These normalizations can be applied in such a way that the NNLF floating point output is mathematically the same before and after normalization.

Note: in the above explanation, if the scaling factor W is propagated to a subsequent layer (j>i+1) which is not immediately following the currently layer (i), then all the intermediate bias layers between ‘i’ to ‘j’ will also need to be normalized by W. This is specified in equation (7) below:

y^{k}=A^{k}x^{k}+B^{k}⇒y^{k′}=A^{k}x^{k}+(B^{k}/W)∀k=(i+1), . . . ,(j−1). (7)

Note that in equation (7) the convolution weights are not modified and only the bias terms are normalized.

The factor that is propagated to subsequent layers (j>i+1) for rescaling is also termed as propagation factor P in Methods 2 and 3 explained below.

The equations (4) to (7) are applicable only if the normalization is done in a forward direction (j>i). If the normalization is done in the backward direction (j<i), the weights and bias of the current layer (i) and previous layers are modified as shown in equations (8), (9) and (10) below:

yⁱ=Aⁱxⁱ+Bⁱ⇒y^{i′}=(Aⁱ/W)xⁱ+Bⁱ (8)

y^{j}=A^{j}x^{j}+B^{j}⇒y^{j′}=y^{j}*W=(A^{j}*W)x^{j}+(B^{j}*W), for j<i (9)

y^{k}=A^{k}x^{k}+B^{k}⇒y^{k′}=A^{k}x^{k}+(B^{k}*W), ∀k=(j+1), . . . ,(i−1) (10)

Note: Further details on when to apply equations (8)-(10) are described later, as part of proposed Method 3.

Based on this weight-normalization principle, the following three different approaches were tested for 16-bit fixed point inference:
1. Localized hidden layer normalization.
2. Global normalization based on largest weight with forward propagation of normalization.
3. Global normalization based on geometric mean and bidirectional propagation of normalization.

### Method 1: Localized Hidden Layer Normalization

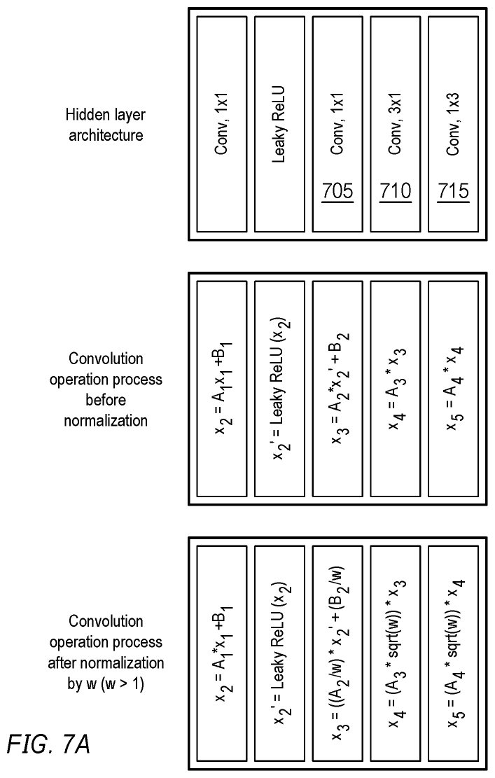

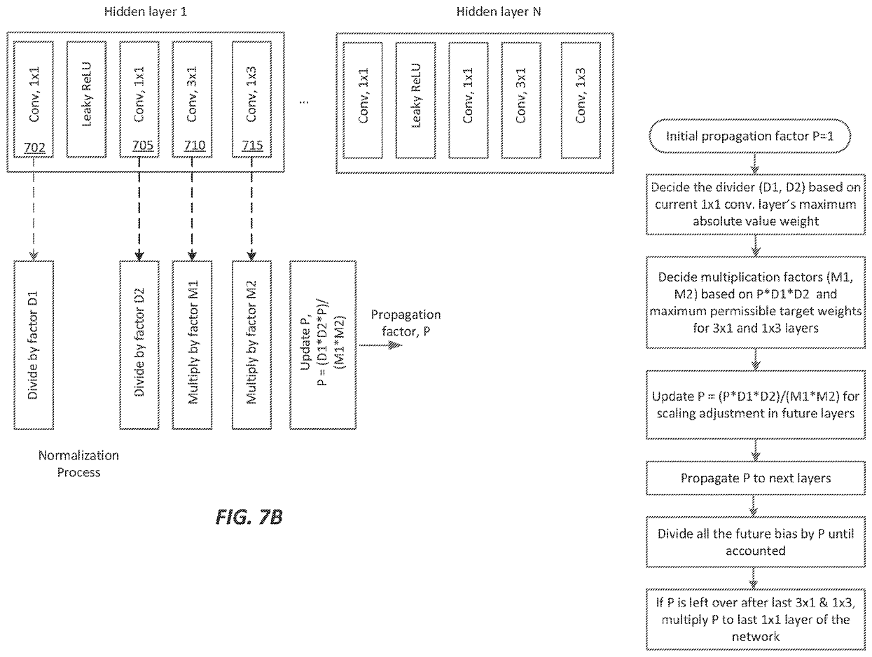

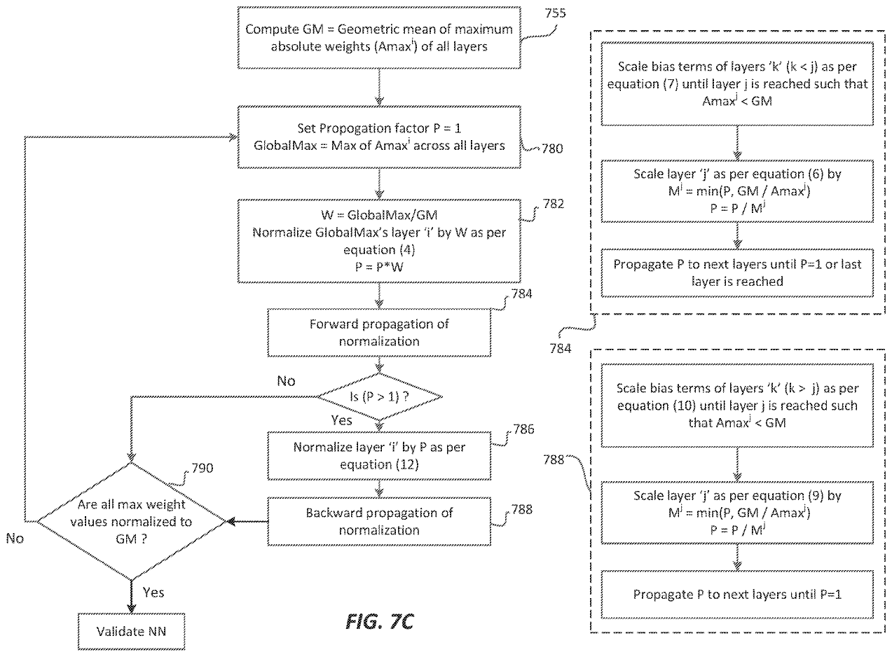

This method is described in FIG. 7A and includes the following steps:
1. The second 1×1 convolution layer (e.g., 705) of each hidden layer is divided by a factor W based on the highest magnitude weight of the layer, so that resulting magnitude is constrained to be less than a fixed threshold (e.g., threshold=4)
2. This division is accommodated by scaling the weights of the next 3×1 and 1×3 (710, 715) convolution layers of the same hidden layer by a factor of \sqrt{W}.
3. The renormalized network is first validated for floating point inference followed by int16 fixed point inference using a dynamic Q factor for convolution weights and fixed Q11 for bias.

The results with this approach are shown in Table 6. The Method 1 results show considerable improvement in int16 coding performance but arc still significantly worse than the performance of int32 with dynamic Q and fixed Q11 for bias (see Table 5). The main conclusions and drawbacks of this method are:
1. Localized normalization can still result in overflows.
2. Insufficient capacity for normalization if scaling factor W is very large due to abnormally high-valued weights.
   Method 2: Global Normalization Based on Largest Weight with Forward Propagation.
   This method is described in FIG. 7B and it includes the following steps:
1. Starting at the first hidden layer, evaluate the maximum magnitude weights for each convolution layer. Initial propagation factor P is set 1.
2. Determine the division factors (Di1, Di2) for each 1×1 convolution layer (702, 705) based on the largest magnitude weight in that layer. Apply the division factors, so that all the 1×1 convolution weights are constrained to be less than 1 in magnitude.
3. Determine multiplication factors (Mi1, Mi2) for subsequent 3×1 and 1×3 convolution layers (710, 715) based on Di1, Di2 as well as any earlier propagation factor P>1. The maximum permissible target weights for 3×1 and 1×3 layers are constrained to be less than a fixed value (say, 5).
4. If (Mi1*Mi2) cannot fully accommodate (P*Di1*Di2), then the propagation factor P is updated to (Di1*Di2*P)/(Mi1*Mi2) and is propagated forward, else if it is fully accommodated P is updated to 1.
5. Divide all the future bias layers by propagation factor (P) until fully accounted during the process.
6. The normalization is done in the forward direction until all 1×1 convolution layers of hidden layers are normalized.
7. The propagation factor P, that is left over after the last 3×1 and 1×3 layers is multiplied to the last 1×1 layer in the network as it cannot be propagated further.
8. The renormalized network is first validated for floating point inference followed by int16 fixed point inference using dynamic Q factor for convolution weights and fixed Q11 for bias.

The results with this approach are also depicted in Table 6. Method 2 shows considerable improvement in int16 coding performance compared to Method 1, but its performance is still worse than the performance of int32 with dynamic Q for weights and with Q11 for bias.

The main conclusions, drawback of this method are:
1. Arbitrary constrains on maximum permissible magnitudes for 1×1, 1×3 and 3×1 convolutions.
2. Uni-directional forward propagation may not be sufficient to completely absorb large propagation factors.

### Method 3: Global Normalization Based on Geometric Mean and Bidirectional Propagation

This method is aimed at finding the geometric mean (GM) of the largest magnitude weights of each layer and iteratively normalizing the network weights such that all the largest magnitude weights are scaled exactly to the GM. The weight propagation is done in both forward and backward directions. Given m numbers, a₁, a₂, . . . aₘ, their geometric mean is defined as

$$GM = \sqrt[m]{\begin{matrix}{a}_{1} & {a}_{2} & … & {a}_{m}\end{matrix}} \qquad ( 11 )$$

This method is described in FIG. 7C and it includes the following steps:
1. Compute the geometric mean (GM) of all the maximum magnitude weights Amaxⁱ=(Max(abs(Aⁱ)) from each layer (755)
2. Initial propagation factor P is set P=1, and GlobalMax=Max(Amaxⁱ) (780).
3. Determine the hidden layer ‘i’ with the highest magnitude weight, and normalize its weights by a scaling factor W such that W=GlobalMax/GM (782). Assuming a subsequent forward propagation (784), adjust its bias values according to equation (4) (782). The propagation factor P is updated to P=P*W.
4. Forward Propagation normalization (784): Propagate the scaling factor P into the layers that are in the forward direction (j>i) and whose maximum weights are less than GM. The weights of the layer ‘j’ whose max weight Amax is less than GM are scaled up by a multiplication factor M=min (P, GM/Amax)) such that their maximum weight after scaling is less than or equal to GM. The scaling operations are done as per equation (6) for layer j and equation (7) for layer k (i<k<j). The propagation factor P is updated to P=P/M^{j}. The forward propagation normalization continues until P becomes 1 or the last layer is reached. Denote as Pb (backward propagation factor) the value of P at the end of the forward propagation normalization. If Pb=P>1, then a backward propagation normalization (788) is needed. Before this step though, the bias values of hidden layer i need to be readjusted as in equation (12) (786), where A^{i′} and B^{i′} denote adjusted values after step 3 (782) using equation (4).

yⁱ=A^{i′}xⁱ+B^{i′}⇒y^{i′}=A^{i′}xⁱ+B^{i′}*Pb. (12)
5. Backward Propagation normalization (788): If the propagation factor P is not fully accounted in the forward direction, it is propagated in the backward direction (j<i). The weights of the layer ‘j’ whose max weight Amax^{j} is less than GM are scaled up by a multiplication factor M^{j}=min (P, GM/Amax^{j}) such that their maximum weight after scaling is less than or equal to GM. The scaling operations are done as per equation (9) for layer j and equation (10) for layer k (j<k<i). The propagation factor P is updated to P/M^{j}. The backward propagation normalization continues until P becomes 1.
6. The largest magnitude of weight across all layers, i.e., GlobalMax varies after each iteration, this is because in each iteration GlobalMax is normalized to GM. It is desired that after the entire process each layer's max weight, i.e., Amaxⁱ will be equal to GM. Thus, steps 3 to 5 (780 to 788) are repeated until all the maximum magnitude weights of each layer are reduced to GM (790). For example, in the first iteration, GlobalMax may be in the i-th layer, but after the first iteration, the i-th layer's max weight is GM (some other layers with Amaxⁱ less than GM will be scaled up to GM accordingly), hence, for the second iteration, GlobalMax will be from a different layer. This process is repeated until the max weight in all layers' weight is equal to GM.
7. The renormalized network is first validated for floating point inference followed by int16 fixed point inference using dynamic Q factor for convolution weights and fixed Q11 for bias.

In another embodiment, in step (782), one may decide to start with a backward propagation (788). Then for hidden layer i its bias values need to be adjusted based on equation (8), and steps (784) and (788) need to be swapped. In addition, denote as Pf (forward propagation factor) the value of P after a backward propagation normalization. If Pf=P>1, and before the forward propagation normalization starts, the bias values of hidden layer i need to be readjusted as in equation (13), where A^{i′} and Bⁱ denoted adjusted values after step 3 (782) using equation (8).

yⁱ=A^{i′}xⁱ+Bⁱ⇒y^{i′}=A^{i′}xⁱ+Bⁱ/Pf. (13)

The results with this approach are also shown in Table 6. Method 3 shows additional improvements in int16 coding performance. The results are only marginally worse than the performance of int32 dynamic Q for weights and with fixed Q11 for the bias values (see Table 5).

TABLE 6
Example Int16 performance and with dynamic weight normalization
All Intra Main10

| | Y- | U- | V- |
|---|---|---|---|
| | PSNR | PSNR | PSNR |
| Method 1 | −3.44% | −3.02% | −2.88% |
| Method 2 | −4.69% | −5.35% | −6.46% |
| Method 3 | −4.77% | −5.61% | −6.32% |

To help better understand Methods 1 to 3, and without limitation, an Appendix is provided with example values of weights and bias values in certain hidden layers, before and after the proposed normalization processes.

### REFERENCES

Each one of the references listed herein is incorporated by reference in its entirety. The term JVET refers to the Joint Video Experts Team of ITU-T SG 16 WP 3 and ISO/IEC JTC 1/SC 29.
[1] Dong Liu, Yue Li, Jianping Lin, Houqiang Li, Feng Wu, “Deep learning-based video coding: A review and a case study,” https://arxiv.org/abs/1904.12462.
[2] Y. Li, K. Zhang, L. Zhang, H. Wang, J. Chen, K. Reuze, A. M. Kotra, M. Karczewicz, “EE1-1.6: Combined Test of EE1-1.2 and EE1-1.4”, JVET-X0066, teleconference, October 2021.
[3] H. Wang, J. Chen, K. Reuze, A. M. Kotra, M. Karczewicz, “EE1-1.4: Tests on Neural Network-based In-Loop Filter with Constrained Computational Complexity,” JVET-X0140, teleconference, October 2021.
[4] L. Wang, X. Xu, S. Liu, “EE1-1.1: neural network based in-loop filter with constrained storage and low complexity,” JVET-Y0078, teleconference, January 2022.
[5] L. Wang, S. Lin, X. Xu, S. Liu, X. Li “E1-1.5: neural network based in-loop filter using depthwise separable convolution and regular convolution.” JVET-X0053, teleconference, October 2021.
[6] V. Lebedev et al., “Speeding-up Convolutional Neural Networks Using Fine-tuned CP-Decomposition”, ICLR 2015.
[7] M. Jaderberg et al., “Speeding up Convolutional Neural Networks with Low Rank Expansions,” Proceedings of the British Machine Vision Conference (BMVC), 2014.
[8] Versatile Video Coding, Rec. ITU-T H.266, August 2020, ITU.
[9] A. Mohananchettiar et. al., “Multi-distribution entropy modeling of latent features in image and video coding using neural networks,” PCT Application Ser. No. PCT/US2022/021730, filed on 24 Mar. 2022.

### Example Computer System Implementation

Embodiments of the present invention may be implemented with a computer system, systems configured in electronic circuitry and components, an integrated circuit (IC) device such as a microcontroller, a field programmable gate array (FPGA), or another configurable or programmable logic device (PLD), a discrete time or digital signal processor (DSP), an application specific IC (ASIC), and/or apparatus that includes one or more of such systems, devices or components. The computer and/or IC may perform, control, or execute instructions relating to loop filtering using neural networks for image and video coding, such as those described herein. The computer and/or IC may compute any of a variety of parameters or values that relate to loop filtering using neural networks for image and video coding described herein. The image and video embodiments may be implemented in hardware, software, firmware and various combinations thereof.

Certain implementations of the invention comprise computer processors which execute software instructions which cause the processors to perform a method of the invention. For example, one or more processors in a display, an encoder, a set top box, a transcoder, or the like may implement methods related to loop filtering using neural networks for image and video coding as described above by executing software instructions in a program memory accessible to the processors. Embodiments of the invention may also be provided in the form of a program product. The program product may comprise any non-transitory and tangible medium which carries a set of computer-readable signals comprising instructions which, when executed by a data processor, cause the data processor to execute a method of the invention. Program products according to the invention may be in any of a wide variety of non-transitory and tangible forms. The program product may comprise, for example, physical media such as magnetic data storage media including floppy diskettes, hard disk drives, optical data storage media including CD ROMs, DVDs, electronic data storage media including ROMs, flash RAM, or the like. The computer-readable signals on the program product may optionally be compressed or encrypted.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (e.g., that is functionally equivalent), including components which are not structurally equivalent to the disclosed structure which performs the function in the illustrated example embodiments of the invention.

### EQUIVALENTS, EXTENSIONS, ALTERNATIVES AND MISCELLANEOUS

Example embodiments that relate to loop filtering using neural networks for image and video coding are thus described. In the foregoing specification, embodiments of the present invention have been described with reference to numerous specific details that may vary from implementation to implementation. Thus, the sole and exclusive indicator of what is the invention, and what is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

### APPENDIX

This appendix provides example numerical results during the normalization process for each of the Methods 1, 2, and 3.

### Method 1

Legend: Normalization by W is shown in Italics, scale by VW is shown in Bold

In all steps, W=8.

Hidden Layer I is processed in Step 1, its coefficients remain the same for all subsequent steps.

Hidden Layer I+1 is processed in Step 2, its coefficients remain the same for all subsequent steps.

Hidden Layer I+2 is processed in Step 3, its coefficients remain the same for all subsequent steps.

Annex Table 1. Example normalization of hidden layers using Method 1

| | | Max values | |
|---|---|---|---|
| Layer ID | Layer Type | before scaling | Scaled Weights |
| | | | Step 1 (W = 8) |
| Hidden Layer I | Conv2d-1 × 1, Weight | 6.8479260 | 6.8479260 |
| | Conv2d-1 × 1, Bias | 2.5265927 | 2.5265927 |
| | Conv2d-1 × 1, Weight | 3.5346480 | 0.4418310 |
| | Conv2d-1 × 1, Bias | 2.0935450 | 0.2616931 |
| | Conv2d-3 × 1, Weight | 0.8445602 | 2.3887770 |
| | Conv2d-1 × 3, Weight | 1.0114741 | 2.8608809 |
| | | | Step 2 (W = 8) |
| Hidden Layer I + 1 | Conv2d-1 × 1, Weight | 4.0041075 | 4.0041075 |
| | Conv2d-1 × 1, Bias | 3.1275606 | 3.1275606 |
| | Conv2d-1 × 1, Weight | 4.6108660 | 0.5763583 |
| | Conv2d-1 × 1, Bias | 5.0256915 | 0.6282114 |
| | Conv2d-3 × 1, Weight | 1.2657973 | 3.5802152 |
| | Conv2d-1 × 3, Weight | 1.1553760 | 3.2678967 |
| | | | Step 3 (W = 8) |
| Hidden Layer I + 2 | Conv2d-1 × 1, Weight | 3.9897400 | 3.9897400 |
| | Conv2d-1 × 1, Bias | 3.6690998 | 3.6690998 |
| | Conv2d-1 × 1, Weight | 5.5560613 | 0.6945077 |
| | Conv2d-1 × 1, Bias | 1.7056351 | 0.2132044 |
| | Conv2d-3 × 1, Weight | 1.4339583 | 4.0558467 |
| | Conv2d-1 × 3, Weight | 0.9736869 | 2.7540023 |

### Method 2

Legend: Normalization by Di1, Di2 is shown in Italics, scale by Mi1, Mi2 is shown in Bold Hidden Layer i (i=1, 2, . . . n) is processed in Step i, and its coefficients remain the same for all subsequent steps.

Annex Table 2. Example normalization of hidden layers using Method 2

| | | Max values | Scaled |
|---|---|---|---|
| Layer ID | Layer Type | before scaling | Weights |
| | | | Step 1 |
| Hidden Layer 1 | Conv2d-1 × 1, Weight | 3.4153273 | 0.8538318 |
| P = 1, D1 = 4, | Conv2d-1 × 1, Bias | 2.2415840 | 0.5603960 |
| D2 = 6, M1 = 3, | Conv2d-1 × 1, Weight | 5.0192804 | 0.8365467 |
| M2 = 4 | Conv2d-1 × 1, Bias | 2.3597982 | 0.0983249 |
| | Conv2d-3 × 1, Weight | 1.4529201 | 4.3587604 |
| | Conv2d-1 × 3, Weight | 1.2464764 | 4.9859056 |
| | | | Step 2 |
| Hidden Layer 2 | Conv2d-1 × 1, Weight | 6.7419524 | 0.9631361 |
| P = 2, D1 = 7, | Conv2d-1 × 1, Bias | 2.2841704 | 0.1631550 |
| D2 = 3, M1 = 4, | Conv2d-1 × 1, Weight | 2.9455059 | 0.9818353 |
| M2 = 3 | Conv2d-1 × 1, Bias | 3.1415627 | 0.0747991 |
| | Conv2d-3 × 1, Weight | 1.1029745 | 4.4118980 |
| | Conv2d-1 × 3, Weight | 1.3198171 | 3.9594512 |
| | | | Step 3 |
| Hidden Layer 3 | Conv2d-1 × 1, Weight | 2.9223952 | 0.9741318 |
| P = 3.5, D1 = 3, | Conv2d-1 × 1, Bias | 2.7991583 | 0.2665865 |
| D2 = 5, M1 = 6, | Conv2d-1 × 1, Weight | 4.1046580 | 0.8209316 |
| M6 = 4 | Conv2d-1 × 1, Bias | 1.3192501 | 0.0251286 |
| | Conv2d-3 × 1, Weight | 0.7592917 | 4.5557504 |
| | Conv2d-1 × 3, Weight | 0.8187077 | 4.9122460 |
| | | | Step n |
| Hidden Layer n | Conv2d-1 × 1, Weight | 1.9753398 | 0.9876699 |
| P = 6.0432, | Conv2d-1 × 1, Bias | 1.4411315 | 0.1192366 |
| D1 = 2, D2 = 2, | Conv2d-1 × 1, Weight | 1.2035555 | 0.6017777 |
| M1 = 24.176, | Conv2d-1 × 1, Bias | 0.6271887 | 0.0259462 |
| M2 = 1 | Conv2d-3 × 1, Weight | 0.1437619 | 3.4751062 |
| | Conv2d-1 × 3, Weight | 0.1405876 | 0.1405876 |
| | Conv2d-1 × 1, Weight | 10.614239 | 10.614239 |
| | Conv2d-1 × 1, Bias | 0.001452145 | 0.001452145 |

### Method 3

GM=1.8981781. Steps 1-3 are example forward propagation normalization steps.

Annex Table 3. Example normalization of hidden layers using Method 1

| | | Max values | Scaled |
|---|---|---|---|
| Layer ID | Layer Type | before scaling | Weights |
| | | | Step 1 (F) |
| Hidden Layer | Conv2d-1 × 1, Weight | 10.6542080 | 1.8981781 |
| “n-3”, | Conv2d-1 × 1, Bias | 3.0777304 | 0.5483355 |
| as layer “i” | Conv2d-1 × 1, Weight | 6.9905386 | 6.9905386 |
| (eq. (4)) | Conv2d-1 × 1, Bias | 35.4982570 | 35.4982570 |
| (P = 1, | Conv2d-3 × 1, Weight | 1.7226094 | 1.7226094 |
| W = 5.61286) | Conv2d-1 × 3, Weight | 1.4670382 | 1.4670382 |
| | | | Step 2 (F) |
| Hidden Layer | Conv2d-1 × 1, Weight | 1.8981781 | 1.8981781 |
| “n-3,” | Conv2d-1 × 1, Bias | 0.5483355 | 0.5483355 |
| as layer “k” | Conv2d-1 × 1, Weight | 6.9905386 | 6.9905386 |
| (eq. (7)) | Conv2d-1 × 1, Bias | 35.4982570 | 6.3244505 |
| (P = 5.61286, | Conv2d-3 × 1, Weight | 1.7226094 | 1.7226094 |
| W = 1) | Conv2d-1 × 3, Weight | 1.4670382 | 1.4670382 |
| | | | Step 3 (F) |
| Hidden Layer | Conv2d-1 × 1, Weight | 1.8981781 | 1.8981781 |
| “n-3,” | Conv2d-1 × 1, Bias | 0.5483355 | 0.5483355 |
| as layer “j” | Conv2d-1 × 1, Weight | 6.9905386 | 6.9905386 |
| (eq. 6)) | Conv2d-1 × 1, Bias | 6.3244505 | 6.3244505 |
| (P = 5.61286, | Conv2d-3 × 1, Weight | 1.7226094 | 1.8981782 |
| W = 1.1019202) | Conv2d-1 × 3, Weight | 1.4670382 | 1.4670382 |
| | | | Step n (F) |
| Hidden Layer | Conv2d-1 × 1, Weight | 4.6616860 | 4.6616860 |
| “n-2” | Conv2d-1 × 1, Bias | 5.0175176 | 1.2745310 |
| as layer “j” | Conv2d-1 × 1, Weight | 9.0219660 | 9.0219660 |
| (eq. 6)) | Conv2d-1 × 1, Bias | 4.2450347 | 1.0783077 |
| (P = 1, | Conv2d-3 × 1, Weight | 0.7578940 | 1.8981781 |
| W = 1.5718462) | Conv2d-1 × 3, Weight | 0.7205653 | 1.1326178 |

1. A method to perform image filtering using neural-networks, the method comprising:
accessing an input image with luma and chroma color components;
applying a first neural network (NN) to both the luma and the chroma color components of the input image to generate a first luma output and a first chroma output;
applying a second neural network to the first luma output to generate a second luma output;
applying a third neural network to the first chroma output to generate a second chroma output; and
concatenating the second luma output and the second chroma output to generate a colored filtered output.

2. The method of claim 1, wherein the first neural network comprises:
a 3×3 convolution (CONV) network with S inputs and M outputs (3×3×S×M),
followed by a non-linear activation (NLA) block,
followed by a 1×1×M×M CONV network and a second NLA block, and
followed by a 1×1×M×K and a 3×3×K×K convolutional networks to generate the first luma output with Ky signals and the first chroma output with Kc signals, wherein K=Ky+Kc.

3. The method of claim 1 wherein the second neural network comprises:
an input of Ky luma signals, and
one or more luma hidden layer blocks, followed by a 3×3×Ky×Ly convolutional blocks to generate the second luma output.

4. The method of claim 3, wherein one of the one or more luma hidden layer blocks comprises:
a 1×1×Ky×My CONV network,
followed by a non-linear activation block,
followed by a 1×1×Ky×Ky CONV network,
followed by a 3×3×Ky×Ky CONV network.

5. The method of claim 1 wherein the third neural network comprise:
an input of Kc chroma signals; and
one or more chroma hidden layer blocks, followed by a 3×3×Kc×Lc convolutional block to generate the second chroma output.

6. The method of claim 5, wherein one of the one or more chroma hidden layer blocks comprises:
a 1×1×Kc×Mc CONV network,
followed by a non-linear activation block,
followed by a 1×1×Mc×Kc CONV network,
followed by a 3×3×Kc×Kc CONV network.

7. The method of claim 4, wherein the 3×3 CONV network is replaced by a CP-decomposition network.

8. The method of claim 7, wherein the CP-decomposition network comprises:
a 1×1×K×R pointwise convolution network, followed by
a 3×1×R×R separable convolution network, followed by
a 1×3×R×R separable convolution network, followed by
a 1×1×R×K pointwise convolution network.

9. The method of claim 8, wherein if the CP-decomposition network is preceded by a 1×1×M×K network, the preceding 1×1×M×K network and the first 1×1×K×R CP-decomposition network can be fused into a single 1×1×M×R network.

10. The method of claim 8, wherein if the CP-decomposition network is followed by a 1×1×K×M network, the last 1×1×R×K CP-decomposition network and the following 1×1×K×M network can be fused into a single 1×1×R×M network.

11. The method of claim 8, wherein the 3×1×R×R separable convolution network followed by the 1×3×R×R separable convolution network are fused together to form a single separable 3×3×R×R convolution network.

12. The method of claim 2, wherein the 3×3 convolution (CONV) network with S inputs and M outputs is replaced by a second CP-decomposition network (420A), the second CP-decomposition network comprising:
4 layers of 1×1×10×R pointwise convolution;
followed by a 3×1×R×R separable convolution;
followed by a 1×3×R×R separable convolution; and
followed by a 1×1×R×M pointwise convolution.

13. The method of claim 2, wherein the neural network comprises an output 3×3×K×L convolution network after the last hidden layer.

14. The method of claim 13, wherein the output 3×3×K×L convolution network (420B) is decomposed into 4 layers comprising: a 1×1×K×R pointwise convolution, followed by a 3×1×R×R separable convolution, followed by a 1×3×R×R separable convolution, and followed by a 1×1×K×L pointwise convolution.

15. The method of claim 2 wherein the neural network comprises an output 3×3×Ky×Ly convolution network after the last hidden layer.

16. The method of claim 15, wherein the output luma 3×3×Ky×Ly convolution (420D) is decomposed into 4 layers of 1×1×Ky×Ry pointwise convolution, followed by a 3×1×Ry×Ry separable convolution, followed by a 1×3×Ry×Ry separable convolution, and followed by 1×1×Ky×Ly pointwise convolution.

17. The method of claim 5, wherein the 3×3×Kc×Lc convolutional block (420C) is decomposed into 4 layers of a 1×1×Kc×Rc pointwise convolution, followed by a 3×1×Rc×Rc separable convolution, followed by 1×3×Rc×Rc separable convolution, and followed by a 1×1×Kc×Lc pointwise convolution.

18. The method of claim 4, wherein one or more components of the neural network are computed using a fixed-point implementation, wherein the fixed-point implementation comprises:
computing (755) a geometric mean (GM) of all maximum absolute value weights in the one or more hidden layer blocks;
a) determining the maximum absolute value weight (GlobalMax) in the “i” hidden layer block among the one or more hidden layer blocks;
b) setting a propagation factor (P) to 1;
c) determining a weight scaling factor (W) as W=GlobalMax/GM;
d) normalizing the “i” hidden layer block based on W, and updating P=P*W;
c) performing forward propagation normalization of other hidden layers based on P;
d) if P>1, performing backward propagation normalization of other hidden layers based on P; and
e) repeating steps a) to d) until each of the maximum absolute value weights in the one or more hidden layer blocks is equal to the geometric mean.

19. The method of claim 18, wherein the step of performing forward propagation normalization comprises computing:
scaling bias values in layers “k” (k=i+1 . . . j−1) as
y^{k}=A^{k}x^{k}+B^{k}⇒y^{k′}=A^{k}x^{k}+(B^{k}/W),
wherein A^{k} and B^{k} denote weights and bias values in hidden layer block k, y^{k} denotes initial outputs, x^{k} denotes hidden layer inputs, and y^{k′} denotes normalized outputs, and
wherein layer j is determined as the layer for which its maximum absolute value weight (Amax^{j}) is smaller than GM;
scaling weight values in layer j as
y=A^{j}x^{j}+B^{j}=(A^{j}*M^{j})*y^{i′}+B^{j}=(A^{j}*M^{j})x^{j′}+B^{j},
wherein
$${M}^{j} = min ( P , \frac{G M}{A {max}^{j}} ) ;$$
setting P=P/MJ; and
propagating P to subsequent hidden layers until P=1 or until reaching the last hidden layer.

20. The method of claim 18, wherein the step of performing backward propagation normalization comprises computing:
scaling bias values in layers “k” (k=j+1 . . . i−1) as
y^{k}=A^{k}x^{k}+B^{k}⇒y^{k′}=A^{k}x^{k}+(B^{k}*W),
wherein A^{k} and B^{k} denote weights and bias values in hidden layer block k, y^{k} denotes initial outputs, x^{k} denotes hidden layer inputs, and y^{k′} denotes normalized outputs, and
wherein layer j is determined as the layer for which its maximum absolute value weight (Amax^{j}) is smaller than GM;
scaling weight values in layer j as
y^{j}=A^{j}x^{j}+B^{j}⇒y^{j′}=y^{j}M^{j}=(A^{j}*M^{j})x^{j}+(B^{j}*M^{j}),
wherein
$${M}^{j} = min ( P , \frac{G M}{A {max}^{j}} ) ;$$
setting P=P/M^{j}; and
propagating P to subsequent hidden layers until P=1.

21. The method of claim 18, wherein in step d) normalizing layer i comprises:
if the propagation normalization is done only in forward direction (j>i)
yⁱ=Aⁱxⁱ+Bⁱ⇒y^{i′}=yⁱ/W=(Aⁱ/W)xⁱ+Bⁱ/W;
else if the propagation normalization is done only in backward direction (j<i)
yⁱ=Aⁱxⁱ+Bⁱ⇒y^{i′}=(Aⁱ/W)xⁱ+Bⁱ,
wherein Aⁱ and Bⁱ denote weights and bias values in hidden layer block i, yⁱ denotes initial outputs, xⁱ denotes hidden layer inputs, and y^{i′} denotes normalized outputs.

22. The method of claim 21 wherein if propagation normalization in a forward direction is followed by propagation normalization in a backward direction, then layer i is renormalized as
yⁱ=Aⁱxⁱ+B^{i′}⇒y^{i′}=A^{i′}xⁱ+B^{i′}*P.

23. A method to process with one or more neural-networks a coded video sequence, the method comprising:
receiving high-level syntax indicating that loop filtering using neural networks (NNLF) is enabled for decoding a current picture;
parsing the high-level syntax for extracting parameters indicating a recommended position of an adaptive loop filter (ALF); and
decoding the current picture based on the ALF position parameters to generate an output picture, wherein the ALF position parameters specify one of:
performing ALF filtering after the NNLF;
performing ALF filtering before the NNLF;
replacing the ALF filtering by a convolutional neural network (CNN) positioned after the NNLF; and
performing ALF filtering before an enhanced NNLF with input ALF classification data.

24. (canceled)

25. (canceled)
